(19) United States
(12) Patent Application Publication
(10) Pub. No.: US 2007/0011263 A1
(43) Pub. Date: Jan. 11, 2007

(54) Remote network disable/re-enable apparatus, systems, and methods

(75) Inventors: John C. Rudelic, Folsom, CA (US); August A. Camber, Rocklin, CA (US); Robert Hasbun, Placerville, CA (US)

Correspondence Address: SCHWEGMAN, LUNDBERG, WOESSNER & KLUTH, P.A., P.O. BOX 2938, MINNEAPOLIS, MN, 55402, US

(73) Assignee: Intel Corporation

(21) Appl. No.: 11/151,391

(22) Filed: Jun. 13, 2005

(51) Int. Cl. G06F 15/16

(52) U.S. Cl. 709/217

(57) ABSTRACT

Apparatus and systems, as well as methods and articles, may operate to receive a disable command from a remote network location to disable a plurality of memory read operations associated with a networked device, authenticate the remote network location using a controller associated with the networked device, and disable the plurality of memory read operations using the controller. Receipt of an enable command may re-enable memory read operations after confidence in the device has been restored.

### TECHNICAL FIELD

Various embodiments described herein relate to memory and storage device technology generally, including apparatus, systems, and methods used to disable and re-enable memory read operations associated with memory and storage devices used in networked clients.

### BACKGROUND INFORMATION

The use of networked devices, including wireless mobile devices (e.g., cellular telephones, personal digital assistants (PDAs), and laptop computers, among others, has become increasingly pervasive in society. These devices may store or permit access to private (e.g., personal and corporate) data, including financial, medical, and legal records, bank and brokerage accounts, and other sensitive information. If the networked device is lost, stolen, infected with a computer virus, or accessed by an unauthorized person, both the device and the private data stored therein may be said to have been potentially compromised. If the private data is accessed by an unauthorized person, the device and the data may be said to have been compromised.

A rightful user of a potentially compromised networked device may present appropriate credentials, including electronic credentials (“authentication”), and file a report with a central authority (e.g., a wireless carrier providing wireless services associated with the device) to register the device as potentially compromised. In order to protect the private data, the central authority may cause the private data to be erased from memory in the device. However, it may be that the device is not in fact compromised (e.g., the device may have been merely temporarily misplaced). Thus, the private data contained therein may have been needlessly erased, or simply been lost during the time of separation from the rightful user. In addition, the device may require re-programming to regain former functionality.

### BRIEF DESCRIPTION OF THE DRAWINGS

FIG. 1 is a block diagram of an apparatus and a representative system according to various embodiments of the invention.

FIG. 2 is a flow diagram illustrating several methods according to various embodiments of the invention.

FIG. 3 is a block diagram of an article according to various embodiments of the invention.

### DETAILED DESCRIPTION

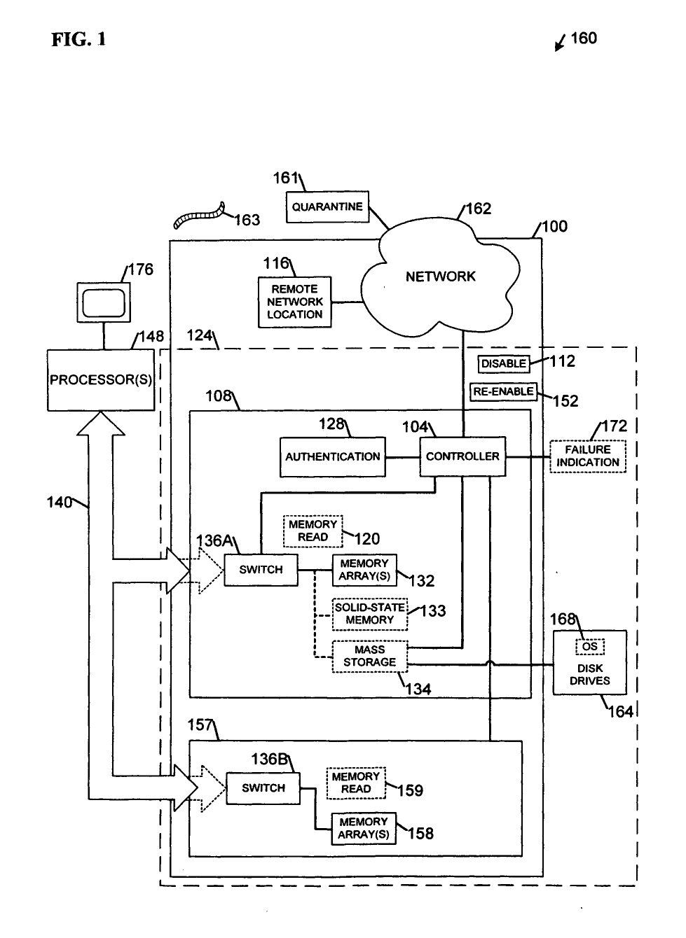

FIG. 1 is a block diagram of an apparatus 100 and a representative system 160 according to various embodiments of the invention. The apparatus 100 may include a controller 104, perhaps located within a first memory module 108 to receive one or more disable command(s) 112 originated from a remote network location 116 to disable a plurality of memory read operations 120 associated with a networked device 124. The disable command(s) 112 may be received directly at the controller or indirectly (e.g., via one or more processor(s) 148). The controller 104 may comprise one or more processors, integrated circuit logic, discrete electronic components, or any combination thereof. Disabling the memory read operations 120 may result in partial or complete disablement of the networked device 124.

The apparatus 100 may also include an authentication module 128 coupled to or included in the controller 104 to authenticate the remote network location 116, and perhaps the disable command(s) 112. In some embodiments, the disable command(s) 112 received by the controller 104 may be authenticated individually, as a group or sub-group, periodically, or using a combination of these methods. Authentication of the disable command(s) 112 may occur implicitly after the remote network location 116 has been authenticated.

The apparatus 100 may further include one or more memory arrays 132 coupled to the controller 104, directly or indirectly, to provide the plurality of memory read operations 120. The memory array(s) 132 may comprise a solid-state memory device 133, a mass storage subsystem 134, or both, among others. The mass storage subsystem 134 may comprise a solid-state storage device, a magnetic storage device, an optical storage device, a magneto-optical storage device, a redundant array of independent disks (RAID) subsystem, and combinations thereof.

Various circuits may operate to disable the plurality of memory read operations 120. For example, a switch 136A may be coupled to the controller 104 to disconnect the memory array(s) 132 from a portion of a bus 140. The bus 140 may comprise a communications link between the memory array(s) 132 and the processor(s) 148. Disconnecting the bus 140 from the memory array(s) 132 may effectively disable some or all operational functionality associated with the networked device 124.

In some embodiments of the apparatus 100, the controller 104 may be programmed to receive a re-enable command 152 from the remote network location 116 to re-enable the plurality of memory read operations 120. The apparatus 100 may also include a second memory module 157 coupled to the controller 104, including one or more additional memory arrays 158 to provide a second plurality of memory read operations 159. Thus, a read disable function, a read re-enable function, or both may be performed by the controller 104 located perhaps within the first memory module 108 and acting upon either or both modules 108, 157, including memory array(s) 132, 158 located within the modules 108, 157, respectively.

Other embodiments may be realized. A system 160 may include one or more of the apparatus 100, similar or identical to that described above, including a controller 104 to receive one or more disable command(s) 112 originated from a remote network location 116 to disable a plurality of memory read operations 120, 159 associated with a networked device 124. The disable command(s) 112 may be received directly at the controller or indirectly (e.g., via one or more processor(s) 148). The memory read operations 120, 159 may be disabled by various circuits, including switch(es) 136A, 136B coupled to the controller 104 to disconnect memory array(s) 132, 158 from a portion of a bus 140. The bus 140 may comprise a parallel bus, a serial bus, or both coupled to a first memory module 108 to transfer data from the module 108 to another location (e.g., to the processor(s) 148).

The controller 104 may also be programmed to receive a re-enable command 152 from the remote network location 116 to re-enable the plurality of memory read operations 120, 159. An authentication module 128 coupled to or included in the controller 104 may be used to authenticate the remote network location 116, the disable command(s) 1-12, and the re-enable command 152, as previously described.

A quarantine module 161 may be coupled to the controller 104, perhaps via a network 162, to generate the disable command 112 upon sensing that the networked device 124 is infected with a computer virus 163. In some embodiments of the system 160, one or more read-disabled disk drive(s) 164 may be coupled to a mass storage subsystem 134 and pre-loaded with a standby copy of an operating system 168 to provide redundancy. The disk drives. 164 may be read-disabled. The disk drive(s) 164 may be re-enabled and/or used to restore a system upon receiving an indication 172 at the controller 104 of a failure in the mass storage subsystem 134.

The system 160 may also include a display 176 coupled to the processor(s) 148, perhaps to display information processed by processor(s) 148, or to display contents of the memory arrays 132, 158. The display 176 may comprise a cathode ray tube display, or a solid-state display such as a liquid crystal display, a plasma display, or a light-emitting diode display, among others. Any of the components previously described can be implemented in a number of ways, including via software. Thus, the apparatus 100; controller 104; memory modules 108, 157; commands 112, 152; remote network location 116; memory read operations 120, 159; networked device 124; authentication module 128; memory arrays 132, 158; memory device 133; mass storage subsystem 134; switches 136A, 136B; bus 140; processor(s) 148; system 160; quarantine module 161; network 162; computer virus 163; disk drives 164; operating system 168; failure indication 172; and display 176 may all be characterized as “modules” herein.

The modules may include hardware circuitry, single and/or multi-processor circuits, memory circuits, software program modules and objects, firmware, and combinations thereof, as desired by the architect of the apparatus 100 and system 160 and as appropriate for particular implementations of various embodiments. Thus, the modules may be included in a system operation simulation package such as a software electrical signal simulation package, a power usage and distribution simulation package, a capacitance-inductance simulation package, a power/heat dissipation simulation package, a signal transmission-reception simulation package, or any combination of software and hardware used to simulate the operation of various potential embodiments. These simulations may be used to design, characterize, or test the embodiments, for example.

It should also be understood that the apparatus and systems of various embodiments may be used in applications other than remotely disabling memory read functionality associated with a networked device. Thus, various embodiments of the invention are not to be so limited. The illustrations of apparatus 100 and system 160 are intended to provide a general understanding of the structure of various embodiments, and are not intended to serve as a complete description of all the elements and features of apparatus and systems that might make use of the structures described herein.

Applications that may include the novel apparatus and systems of various embodiments include electronic circuitry used in high-speed computers, communication and signal processing circuitry, modems, single or multi-processor modules, single or multiple embedded processors, data switches, and application-specific modules, including multilayer, multi-chip modules. Such apparatus and systems may further be included as sub-components within a variety of electronic systems, such as televisions, cellular telephones, personal computers, workstations, radios, video players, vehicles, and others. Some embodiments may include a number of methods.

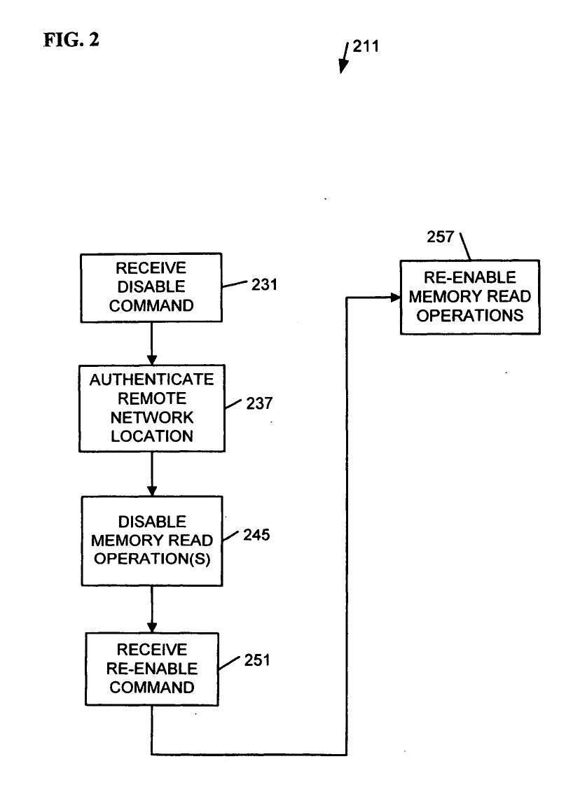

FIG. 2 is a flow diagram illustrating several methods 211 according to various embodiments of the invention. One such method 211 may begin with receiving a disable command from a remote network location to disable a plurality of memory read operations associated with a first memory module, a second memory module, and/or a networked device, at block 231. The method 211 may continue with authenticating the remote network location and perhaps the disable command using a controller associated with the networked device, at block 237. The controller may be located within a first memory module associated with the networked device. The controller may comprise one or more processors, integrated circuit logic, discrete electronic components, or any combination thereof.

The method 211 may also include disabling one or more pluralities of memory read operations, perhaps using one or more controllers, at block 245. For example, the one or more pluralities of memory read operations may be disabled upon detecting that the networked device is infected with a computer virus, or upon receiving a report that the networked device has otherwise been potentially compromised. The disabled plurality of memory read operations may include one or more key-press operations, but may exclude others. A key-press sequence required to call an emergency service may be excluded from the disable operation(s), for example. The disabled plurality of memory read operations may also exclude read operations associated with an execution code module operating to re-enable the plurality of memory read operations (e.g., so device functionality is more easily re-enabled after authentication).

The method 211 may further include receiving a re-enable command from the remote network location to re-enable the plurality of memory read operations, at block 25 1. The disable command, the re-enable command, or both, may be authenticated. The method 211 may conclude with re-enabling the plurality of memory read operations, perhaps at a time after restoring confidence in the potentially compromised networked device, at block 257. Confidence may be restored, for example, by recovering the potentially compromised networked device and scanning the networked device for viruses and unauthorized access to device data.

The methods described herein do not have to be executed in the order described, or in any particular order. Moreover, various activities described with respect to the methods identified herein can be executed in repetitive, serial, or parallel fashion. Information, including parameters, commands, operands, and other data, can be sent and received in the form of one or more carrier waves.

One of ordinary skill in the art will understand the manner in which a software program can be launched from a computer-readable medium in a computer-based system to execute the functions defined in the software program. Various programming languages may be employed to create one or more software programs designed to implement and perform the methods disclosed herein. The programs may be structured in an object-orientated format using an object-oriented language such as Java or C++. Alternatively, the programs can be structured in a procedure-orientated format using a procedural language, such as assembler or C. The software components may communicate using a number of mechanisms well known to those skilled in the art, such as application program interfaces or inter-process communication techniques, including remote procedure calls. The teachings of various embodiments are not limited to any particular programming language or environment. Thus, other embodiments may be realized.

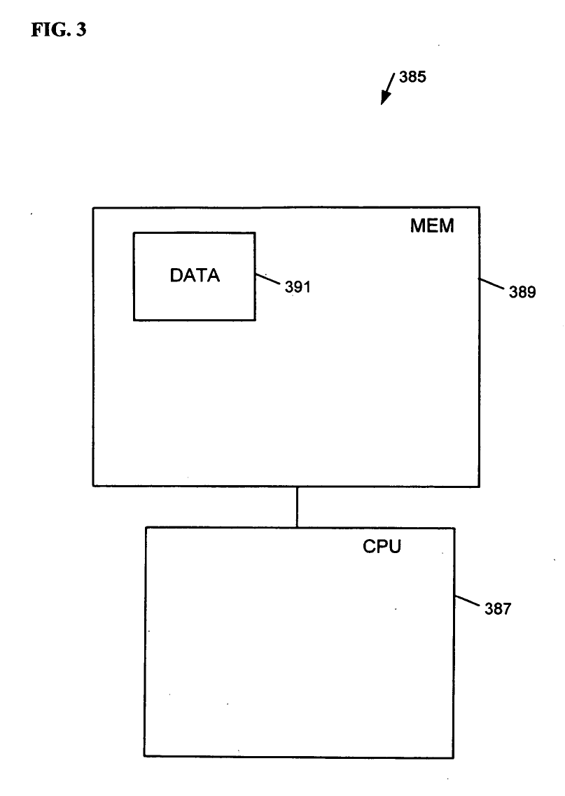

FIG. 3 is a block diagram of an article 385 according to various embodiments of the invention. Examples of such embodiments may comprise a computer, a memory system, a magnetic or optical disk, some other storage device, or any type of electronic device or system. The article 385 may include one or more processor(s) 387 coupled to a machine-accessible medium such as a memory 389 (e.g., a memory including an electrical, optical, or electromagnetic conductor). The medium may contain associated information 391 (e.g., computer program instructions, data, or both) which, when accessed, results in a machine (e.g., the processor(s) 387) receiving a disable command from a remote network location to disable a plurality of memory read operations associated with a networked device.

Other activities may include authenticating the remote network location using a controller associated with the networked device, and disabling the plurality of memory read operations, perhaps using one or more controllers. The plurality of memory read operations may be disabled upon detecting that the networked device is infected with a computer virus, for example, or that the networked device has been potentially compromised. Additional activities may include re-enabling the plurality of memory read operations associated with the potentially compromised device at a time after restoring confidence in the device.

Implementing the apparatus, systems, and methods disclosed herein may enable reception of a command from an authenticated remote network location to disable and re-enable memory read operations associated with a networked device, perhaps utilizing a controller internal to a memory module associated with the networked device. Increased security, combined with consumer-friendly operation, may result.

The accompanying drawings that form a part hereof show, by way of illustration and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted to require more features than are expressly recited in each claim. Rather, inventive subject matter may be found in less than all features of a single disclosed embodiment. Thus the following claims are hereby incorporated into the Detailed Description, with each claim standing on its own as a separate embodiment.

What is claimed is:

1. An apparatus, including:
a controller located within a first memory module to receive a disable command originated from a remote network location to disable a plurality of memory read operations associated with a networked device; and
an authentication module coupled to the controller to authenticate the remote network location.

2. The apparatus of claim 1, further including:
at least one memory array coupled to the controller to provide the plurality of memory read operations.

3. The apparatus of claim 2, wherein the at least one memory array comprises at least one solid-state memory device.

4. The apparatus of claim 2, wherein the at least one memory array comprises a mass storage subsystem.

5. The apparatus of claim 4, wherein the mass storage subsystem comprises at least one of a solid-state storage device, a magnetic storage device, an optical storage device, a magneto-optical storage device, and a redundant array of independent disks subsystem.

6. The apparatus of claim 2, further including:
a switch coupled to the controller to disconnect the at least one memory array from a portion of a bus.

7. The apparatus of claim 6, wherein the bus comprises a communications link between the at least one memory array and a processor.

8. The apparatus of claim 1, wherein the controller is programmed to receive a re-enable command from the remote network location to re-enable the plurality of memory read operations.

9. The apparatus of claim 8, wherein at least one of the disable command and the re-enable command is authenticated.

10. The apparatus of claim 1, further including: a second memory module coupled to the controller, including at least one additional memory array to provide a second plurality of memory read operations.

11. A system, including:
a controller located within a first memory module to receive a disable command originated from a remote network location to disable a plurality of memory read operations associated with a networked device;
an authentication module coupled to the controller to authenticate the remote network location;
a parallel bus coupled to the first memory module to transfer data from the first memory module to a processor; and
a liquid crystal display coupled to the processor.

12. The system of claim 11, further including:
at least one memory array coupled to the controller to provide the plurality of memory read operations.

13. The system of claim 12, wherein the at least one memory array comprises a mass storage subsystem.

14. The system of claim 13, further including:
at least one read-disabled disk drive coupled to the mass storage subsystem to re-enable upon receiving an indication of a failure in the mass storage subsystem, wherein the disk drive is pre-loaded with a standby copy of an operating system.

15. The system of claim 12, further including:
a switch coupled to the controller to disconnect the at least one memory array from a portion of a bus.

16. The system of claim 11, wherein the controller is programmed to receive a re-enable command from the remote network location to re-enable the plurality of memory read operations.

17. The system of claim 11, further including:
a quarantine module coupled to the controller to generate the disable command upon sensing that the networked device is infected with a computer virus.

18. A method, including:
receiving a disable command from a remote network location to disable a plurality of memory read operations associated with a networked device;
authenticating the remote network location using a controller associated with the networked device; and
disabling the plurality of memory read operations.

19. The method of claim 18, wherein the plurality of memory read operations is disabled using at least one of the controller and a second controller.

20. The method of claim 18, wherein the controller is located within a first memory module associated with the networked device.

21. The method of claim 18, further including:
receiving a re-enable command from the remote network location to re-enable the plurality of memory read operations; and
re-enabling the plurality of memory read operations.

22. The method of claim 21, wherein at least one of the disable command and the re-enable command is authenticated.

23. The method of claim 18, wherein the plurality of memory read operations is associated with at least one of a first memory module and a second memory module.

24. The method of claim 18, wherein the disabled plurality of memory read operations includes at least one key-press operation.

25. The method of claim 24, wherein the at least one key-press operation excludes a key-press sequence to call an emergency service.

26. The method of claim 18, wherein the disabled plurality of memory read operations excludes read operations associated with an execution code module operating to re-enable the plurality of memory read operations.

27. An article including a machine-accessible medium having associated information, wherein the information, when accessed, results in a machine performing:
receiving a disable command from a remote network location to disable a plurality of memory read operations associated with a networked device;
authenticating the remote network location using a controller associated with the networked device; and
disabling the plurality of memory read operations.

28. The article of claim 27, wherein the plurality of memory read operations is disabled upon detecting that the networked device is infected with a computer virus.

29. The article of claim 27, wherein the information, when accessed, results in a machine performing:
re-enabling memory read operations associated with the networked device, wherein the networked device has been potentially compromised, at a time after restoring confidence in the potentially compromised networked device.

30. The article of claim 27, wherein the plurality of memory read operations is disabled using at least one of the controller and a second controller.
